(19) United States
(12) Patent Application Publication
(10) Pub. No.: US 2008/0145714 A1
(43) Pub. Date: Jun. 19, 2008

(54) Fuel Cell System and Related Method

(75) Inventor: Fumio Kagami, Kanagawa-ken (JP)

Correspondence Address: FOLEY AND LARDNER LLP;SUITE 500, 3000 K STREET NW, WASHINGTON, DC, 20007, US

(73) Assignee: NISSAN MOTOR CO., LTD.

(21) Appl. No.: 10/589,278

(22) PCT Filed: Feb. 8, 2005
(86) PCT No.: PCT/JP06/02197

§ 371 Date: Aug. 11, 2006

(30) Foreign Application Priority Data
Feb. 13, 2004 (JP) 2004-037148

(51) Int. Cl. H01M 8/04

(52) U.S. Cl. 429/13; 429/24; 429/23

(57) ABSTRACT

A fuel cell system (S1, S2, S3, S4, S5) includes a fuel cell (1) supplied with fuel and oxidizer to generate electric power, a heating mechanism (6, 31, 32) executing a heating to the fuel cell, a temperature detector (7) detecting a temperature of the fuel cell, and a controller (5) operative to calculate a temperature drop speed of the fuel cell, during a period in which the temperature of the fuel cell is lowering, using the temperature of the fuel cell detected by the temperature detector to control the heating mechanism such that the temperature crop speed is kept equal to or less than a given speed.

### TECHNICAL FIELD

The present invention relates to a fuel cell system and its related method and more particularly, to a fuel cell system and its related method that suppresses deterioration in performance of a fuel cell kept in extremely low temperatures such as freezing temperatures.

### BACKGROUND ART

A fuel cell system is an electric power generation system in which hydrogen, serving as fuel, and air, serving as oxidizer, are supplied to a fuel cell to allow electrochemical reaction to take place in the fuel cell to generate electric power.

With such a fuel cell system, tendencies occur wherein when the fuel cell is kept under circumstances where operation of the system is stopped, surrounding environmental temperatures reach extremely low temperatures, such as freezing temperatures, with a resultant drop in temperature of the fuel cell to the extremely low temperatures and performance of the fuel cell is degraded.

Japanese Patent Application Laid-Open Publication No. 7-169476 discloses technology wherein in case where a temperature drop occurs during a halt of the system, fuel, for use in the fuel cell to generate electric power, is supplied to a combustor for combustion to allow resultant heat to keep the fuel cell warm in order to prevent performance degradation of the fuel cell during the keeping thereof without the use of an external power supply.

### DISCLOSURE OF INVENTION

However, upon studies conducted by the present inventor, in order for the fuel cell to be kept warm during such a system halt, a need arises for continuously consume fuel, to be used in the fuel cell for generating electric power by nature, in the combustor. Thus, it can be predicted that not only factors for cause of degradation in efficiency arise but also situations arises where, depending on circumstances, an inability occurs in start-up of the system due to a shortage in supply of fuel when starting up the system.

Upon persevered efforts in various studies conducted by the present inventor with various views, related to performance degradation of the fuel cell resulting from the temperature drop of the fuel cell, in mind, it has been found out that a degree of degradation in temperature of the fuel cell largely depends on a temperature drop speed (a speed at which temperatures drop) when the temperature of the fuel cell is lowering.

That is, upon studying work conducted by the present inventor, it has been turned out that performance degradation of a fuel cell progresses in the presence of a temperature drop occurring at a fast speed during a period wherein a temperature of a fuel cell is lowering whereas, in contrast, if the temperature drop speed of the fuel cell is slow, relatively less degradation in performance occurs even in the presence of a drop in temperature of the fuel cell to a value below a freezing point.

The present invention has been completed upon such studies conducted by the present inventor as set forth above and has an object to provide a fuel cell system and its related method wherein a fuel cell system is efficiently heated without consuming a large amount of energy during a halt of the system for thereby keeping a fuel cell from degrading in performance due to a drop in temperature of the fuel cell.

To achieve such an object, one aspect of the present invention provides a fuel cell system comprising: a fuel cell supplied with fuel and oxidizer to generate electric power; a heating mechanism executing a heating to the fuel cell; a temperature detector detecting a temperature of the fuel cell; and a controller operative to calculate a temperature drop speed of the fuel cell, during a period in which the temperature of the fuel cell is lowering, using the temperature of the fuel cell detected by the temperature detector to control the heating mechanism such that the temperature drop speed is kept equal to or less than a given speed.

In other words, another aspect of the present invention provides a fuel cell system comprising: a fuel cell supplied with fuel and oxidizer to generate electric power; heating means for executing a heating to the fuel cell; temperature detection means for detecting a temperature of the fuel cell; and control means, by calculating a temperature drop speed of the fuel cell, during a period in which the temperature of the fuel cell is lowering, based on the temperature of the fuel cell detected by the temperature detection means, for controlling the heating means such that the temperature drop speed is kept equal to or less than a given speed.

In the meanwhile, the other aspect of the present invention provides a method of controlling a fuel cell system having a fuel cell supplied with fuel and oxidizer to generate electric power, the method comprising: detecting a temperature of the fuel cell; calculating a temperature drop speed, during a period in which the temperature of the fuel cell is lowering, using the temperature of the fuel cell; and executing a heating to the fuel cell such that the temperature drop speed is kept equal to or less than a given speed.

Other and further features, advantages, and benefits of the present invention will become more apparent from the following description taken in conjunction with the following drawings.

### BRIEF DESCRIPTION OF DRAWINGS

FIG. 1 is a view illustrating a block diagram of a fuel cell system of a first embodiment according to the present invention;

FIG. 2 is a cross-sectional view typically showing a structure of an electric power-generating cell that forms one unit of a solid oxide fuel cell of the presently filed embodiment;

FIG. 3A is a graph illustrating the relationship between operation control of an electric heater, to be executed by a control unit, and time variation in temperature drop speed Vc of the fuel cell, in the presently filed embodiment;

FIG. 3B is a graph illustrating the relationship between operation control of an electric heater, to be executed by a control unit, and time variation in temperature T1 of the fuel cell, in the presently filed embodiment;

FIG. 4 is a flowchart illustrating the operation control of the electric heater to be executed by the control unit in the fuel cell system of the presently filed embodiment;

FIG. 5 is a graph illustrating the relationship between a temperature drop speed, under a situation where the fuel cell is lowering in temperature to extremely low temperatures, and corresponding 1 (current density)-V (voltage) characteristic of the fuel cell, in the presently filed embodiment;

FIG. 6 is a view illustrating a block diagram of a fuel cell system of a second embodiment according to the present invention;

FIG. 7 is a flowchart illustrating the operation control of the electric heater to be executed by the control unit in the fuel cell system of the presently filed embodiment;

FIG. 8 is a flowchart illustrating the operation control of the electric heater to be executed by a control unit in a fuel cell system of a third embodiment according to the present invention;

FIG. 9 is a view illustrating a block diagram of a fuel cell system of a fourth embodiment according to the present invention; and

FIG. 10 is a view illustrating a block diagram of a fuel cell system of a fifth embodiment according to the present invention.

### BEST MODE FOR CARRYING OUT THE INVENTION

Hereinafter, fuel cell systems and their methods of respective embodiments according to the present invention are described in detail with reference to the accompanying drawings.

### First Embodiment

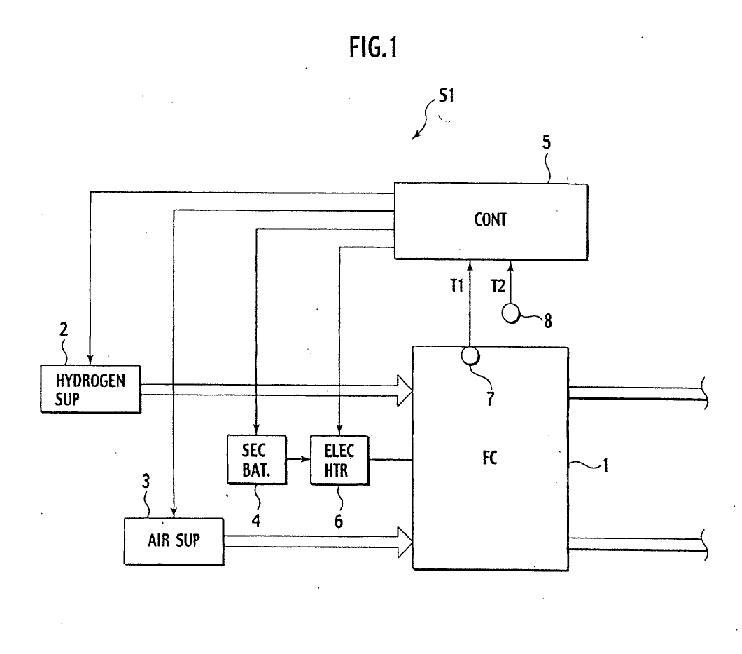

First, a control device for a fuel cell system and its related method of a first embodiment according the present invention are described below with reference to FIGS. 1 to 5.

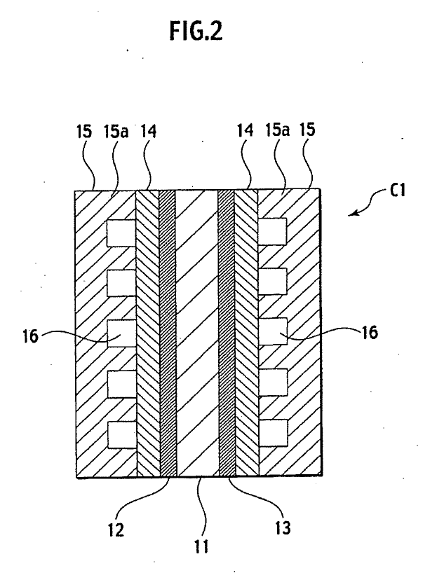

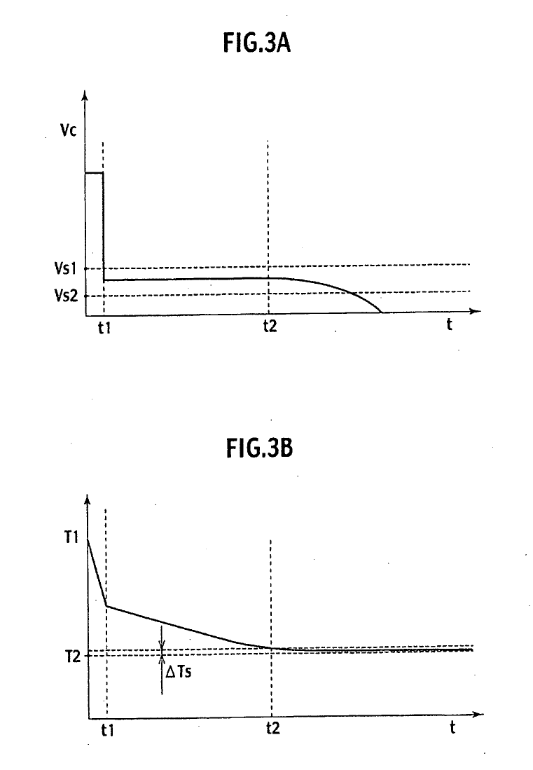

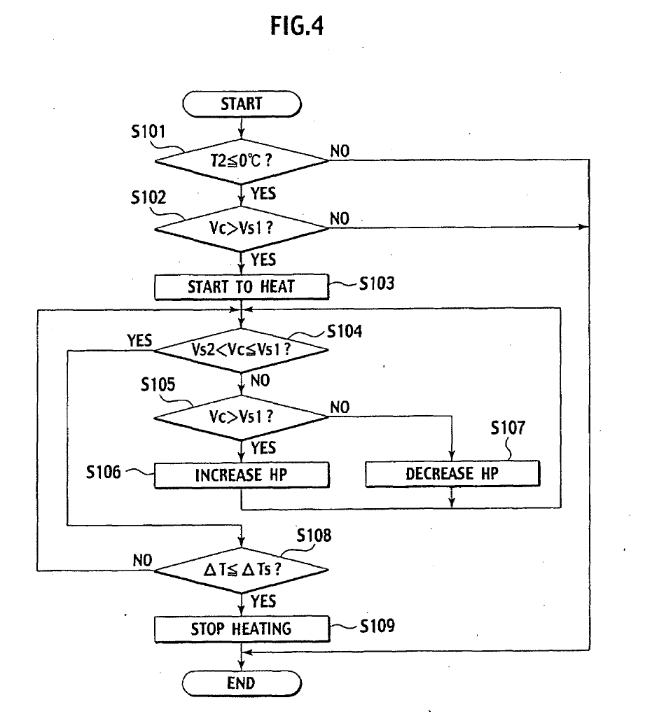

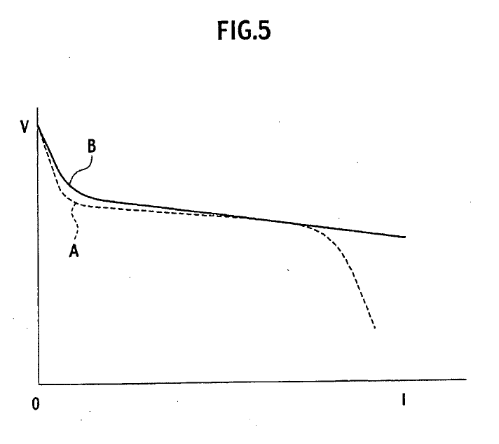

FIG. 1 is a view illustrating a block diagram of a fuel cell system of the presently filed embodiment; FIG. 2 is a cross-sectional view typically showing a structure of an electric power-generating cell that forms one unit of a solid oxide fuel cell of the presently filed embodiment; FIG. 3A is a graph illustrating the relationship between operation control of an electric heater, to be executed by a control unit, and time variation in temperature drop speed Vc of the fuel cell, in the presently filed embodiment; FIG. 3B is a graph illustrating the relationship between operation control of an electric heater, to be executed by a control unit, and time variation in temperature T1 of the fuel cell, in the presently filed embodiment; FIG. 4 is a flowchart illustrating the operation control of the electric heater to be executed by the control unit in the fuel cell system of the presently filed embodiment; FIG. 5 is a graph illustrating the relationship between a temperature drop speed, under a situation where the fuel cell is lowering in temperature to extremely low temperatures, and corresponding I (current density)-V (voltage) characteristic of the fuel cell, in the presently filed embodiment.

As shown in FIG. 1, the fuel cell system S1 plays a role as an electric power-generating system that includes a fuel cell 1 having a fuel electrode supplied with hydrogen from a hydrogen supply unit 2 and an oxidizer electrode supplied with air, serving as oxidizer, from an air supply unit 3 to cause electrochemical reaction in the fuel cell 1 to generate electric power.

The fuel cell 1 electrochemically reacts hydrogen supplied to the fuel electrode and air supplied to the oxidizer electrode to directly convert chemical energy, owned by hydrogen serving as fuel, to electrical energy and electrode reactions, which proceed on both the fuel electrode and the oxidizer electrode of the fuel cell 1, are expressed below.

Fuel Electrode: 2H₂→4H⁺+4e⁻ (1)

Oxidizer Electrode: 4H⁺+4e⁻+O₂→2H₂O (2)

That is, with hydrogen, serving as fuel, supplied to the fuel cell 1 from the hydrogen supply unit 2, the reaction expressed in a formula (1) proceeds on the fuel electrode, creating hydrogen ions. The resulting hydrogen ions permeate (diffuse) through an electrolyte to reach the oxidizer electrode. When this takes place, if air, serving as oxidizer, is supplied from the air supply unit 3, the reaction expressed in a formula (2) proceeds on the oxidizer electrode. With the electrode reactions proceeding on the respective electrodes as expressed in the above formulae (1) and (2), electromotive forces occur in the fuel cell 1.

The fuel cell 1 is classified into various types depending on differences in electrolytes. The fuel cell system of the presently filed embodiment employs a solid oxide fuel cell (SOFC) that includes an electrolyte composed of a solid polymer membrane. The SOFC has features in that it is easy to be manufactured at low cost, small in size and lightweight and has a high output density.

The SOFC is comprised of multiple electric power-generating cells, one cell C1 of which is shown in FIG. 2 and which are stacked in a lateral direction in FIG. 2. Each electric power-generating cell C1 includes an electrolyte membrane 11, composed of a solid polymer membrane, two electrodes (a fuel electrode 12 and an oxidizer electrode 13) disposed on both sides of the electrolyte membrane 11 so as to sandwich the electrolyte membrane 11, gas diffusion layers 14 placed on the fuel electrode 12 and the oxidizer electrode 13 so as to cover these components, and separators 15 serving as respective partition walls each between adjacent cells.

The electrolyte membrane 11 is made of ion (proton) conductive solid polymer membrane, such as an ion-exchange membrane of fluorine contained resin family, and upon saturation with water, functions as an ion conductive electrolyte.

The fuel electrode 12 and the oxidizer electrode 13, placed on the both surfaces of the electrolyte membrane 11, are formed of a carbon cross or a carbon paper, containing catalyst such as platinum or platinum and other metals, and each has a surface, on which the catalyst is present, which is held in contact with an associated surface of the electrolyte membrane 11.

Of these electrodes, the fuel electrode 12 is supplied with hydrogen that is dissociated into hydrogen ions and electrons whereupon the hydrogen ions permeates through the electrolyte membrane 11 while the electrons passes through an external circuit to generate electric power and they move to the oxidizer electrode 13, respectively. On the other hand, on the oxidizer electrode 13, oxygen contained in supplied air and the hydrogen ions and electrons passed through the electrolyte membrane 11 react with one another, thereby creating water.

The gas diffusion layers 14 have gas diffusion effects by which hydrogen and air are supplied to the fuel electrode 12 and the oxidizer electrode 13, respectively.

The separators 15 not only have a function to serve as respective partition walls associated with the adjacent electric power-generating cell but also have a function to serve as respective current collectors and respective flow channels for reaction gases (hydrogen and air) and are formed of dense carbon material that is gas-impermeable. One surface or both surfaces of each separator 15 are formed with a number of ribs 15a to enhance flow channels for hydrogen or air. Hydrogen and air are supplied from respective gas inlets formed in the separators 15, respectively, to pass through gas channels 16, defined by the ribs 15a, whereupon gases are exhausted from respective gas outlets.

While a detailed illustration of the hydrogen supply unit 2, by which hydrogen, serving as fuel, is supplied to the fuel cell 1 with such a structure, is herein omitted and the hydrogen supply unit 2 takes the form of a structure wherein hydrogen stored in a hydrogen storage vessel, such as a hydrogen tank, is extracted under reduced pressure and regulated to a given pressure and flow rate whereupon hydrogen is supplied to the fuel electrode of the fuel cell under a humidified condition.

Further, although a detailed illustration of the air supply unit 3 is herein omitted, the air supply unit 3 takes the form of a structure wherein outside air is drawn by driving a compressor at a given flow rate and then is cleaned using a filter whereupon air is regulated at a given pressure and supplied to the oxidizer electrode of the fuel cell 1 under a humidified condition.

Further, with the fuel cell system of the presently filed embodiment, although a detailed illustration of the fuel cell 1 is herein omitted, the fuel cell 1 is arranged to be coupled to loads, such as a motor and auxiliary devices, via a power conversion device to allow electric power, extracted from the fuel cell 1 during electric power generation thereof, to be stepped up and supplied to the loads such as the motor and the auxiliary devices. Also, connected to these loads in parallel to the fuel cell 1 is a secondary battery 4 whose discharging voltage is utilized for supplementing a shortage of electric power generated by the fuel cell 1.

A control unit 5 controls the operations of a whole of the fuel cell system.

More particularly, the control unit 5 calculates the amount of electric power demanded by the loads, such as the motor and the auxiliary devices, to determine output allocations of the fuel cell 1 and the secondary battery 4 depending on operating conditions of the system and statuses of the fuel cell 1. Then, acquiring the amount of electric power generation demanded to the fuel cell 1 permits the operations of the hydrogen supply unit 2 and the air supply unit 3 to be controlled. In addition, the control unit 5 performs various controls, for normally actuating the fuel cell system, involving control for allowing the fuel cell 1 to be maintained at appropriate operating temperatures and control for enhancing optimum humidified condition.

During a period in which the fuel cell system set forth above is kept under a condition wherein the system remains halt, that is, the system is not operated, surrounding environmental temperatures gets extremely low temperatures below a freezing point followed by a rapid drop in temperature of the fuel cell 1, causing the fuel cell 1 to degrade in performance.

To address such an issue, the fuel cell system of the presently filed embodiment contemplates the provision of an electric heater 6 in the vicinity of the fuel cell 1 whereby when the fuel cell system is subjected to the extremely low temperatures such as when the environmental temperature drops below the freezing point during a halt of the system, the electric heater 6 is activated using the secondary battery 4, serving as a power supply, to heat the fuel cell 1 for thereby suppressing the occurrence of performance degrading of the fuel cell 1 due to rapid drop in temperature. Particularly, in view of a new expertise in that the degree of performance degrading of the fuel cell 1 is heavily dependent on a speed (temperature drop speed) at which the temperature of the fuel cell 1 drops, the fuel cell system of the presently filed embodiment is arranged to allow the control unit to control the operation of the electric heater 6 in a way to heat the fuel cell 1 under an optimum condition such that the temperatures of the fuel cell 1 are gradually lowered at a temperature drop speed equal to or less than a given speed so as to allow the temperature of the fuel cell 1 to approach to the environmental temperature. Incidentally, the electric heater 6 may be sufficed to be located at any position provided that the fuel cell 1 can be heated and, as far as this concerns, it doesn't matter if it is separated from the fuel cell 1.

Hereunder, a concrete content for controlling the operation of the electric heater 6 to be executed by the control unit 5 is described with reference to FIGS. 3A and 3B.

Mounted in the fuel cell system are a temperature sensor 7, by which a temperature T1 of the fuel cell 1 is detected, and a temperature sensor 8 for detecting an environmental temperature T2 in the vicinity of the fuel cell 1, and detected values T1, T2 of these temperature sensors 7, 8 are inputted to the control unit 5. Incidentally, the environmental temperature of in the vicinity of the fuel cell 1 may include an environmental temperature of an inside of a vehicle in which the fuel cell is installed. Of course, depending on circumstances, it may be possible to employ an environmental temperature of an outside of the vehicle in which the fuel cell 1 is installed.

The control unit 5 calculates the temperature drop speed Vc of the fuel cell 1 based on the detected value T1 of the temperature sensor 7 in terms of change in time and discriminates the environmental temperature in the vicinity of the fuel cell 1 based on the detected value T2 of the temperature sensor 8. If for example, discrimination is made that the environmental temperature T2 in the vicinity of the fuel cell 1 is equal to or less than 0° C. and the temperature drop speed Vc of the fuel cell 1 exceeds a given reference value (of first given speed Vs1) forming a criteria, then, the control unit 5 activates the electric heater 6 to heat the fuel cell 1. Incidentally, the first given speed Vs1 is a threshold value, which forms a criterion for judging whether performance degrading of the fuel cell 1 occurs due to the temperature drop, and obtained by experimental tests that are preliminarily conducted.

Thereafter, the control unit 5 regulates a heating capacity of the electric heater 6 upon monitoring the temperature drop speed Vc of the fuel cell 1 in a way to allow the temperature drop speed of the fuel cell 1 to be maintained between the first given speed Vs1, serving as the reference value, and a second given speed Vs2 that forms a criteria and a threshold value less than the first speed Vs1. When the temperature T1 of the fuel cell 1 gradually lowers and a temperature difference Ts between the temperature T1 of the fuel cell 1 and the environmental temperature T2 in the vicinity of the fuel cell 1 reaches a predetermined given temperature difference ΔTs, the control unit 5 stops the operation of the electric heater 6.

That is, as shown in FIG. 3A, the control unit 5 starts to heat the fuel cell 1 using the heater 6 when the temperature drop speed Vc of the fuel cell 1 exceeds the first given speed Vs1 (at time t1) and regulates the heating capacity of the electric heater 6 to allow the temperature drop speed of the fuel cell 1 to be maintained between the first given speed Vs1 and the second given speed Vs2. Subsequently, as shown in FIG. 3B, in the stage wherein the temperature T1 of the fuel cell 1 gradually drops to approach to the environmental temperature T2 in the vicinity of the fuel cell 1 and the temperature difference reaches the given temperature difference ΔTs, the control unit 5 stops the operation of the electric heater 6 heating the fuel cell 1 (at time t2).

A further concrete content of controlling the operation of the electric heater 6 to be executed by the control unit 5, as set forth above, is described with reference to a flowchart shown in FIG. 4.

As shown in FIG. 4, in first step S101, during a halt of the fuel cell system, the control unit 5 reads the detected value of the temperature sensor 8 to acquire the environmental temperature in the vicinity of the fuel cell 1 and discriminates whether the environmental temperature in the vicinity of the fuel cell 1 is equal to or less than 0° C. Here, if the environmental temperature in the vicinity of the fuel cell 1 is equal to or less than 0° C., the operation proceeds to step S102.

Next, in step S102, the control unit 5 monitors the detected value of the temperature sensor 7 in terms of time to calculate a speed (temperature drop speed) [° C./h] at which a temperature of the fuel cell 1 drops and discriminates whether the temperature drop speed Vc, resulting from calculation, of the fuel cell 1 exceeds the first given speed Vs1. Here, if the temperature drop speed Vc of the fuel cell 1 is equal to or less than the first given speed Vs1, then, the operation is terminated intact. In contrast, if the temperature drop speed Vc of the fuel cell 1 exceeds the first given speed Vs1, the operation proceeds to step S103.

In succeeding step S103, the control unit 5 sends a discharging request to the secondary battery 4 and control command to the electric heater 6, thereby activating the electric heater 6 to start to heat the fuel cell 1. Subsequently, the control unit 5 monitors the detected value of the temperature sensor 7 at all times to oversee variation in the temperature drop speed Vc of the fuel cell 1 such that the temperature of the fuel cell 1 is lowered so as to approach to the environmental temperature. Then, the control unit 5 controls a heating condition of the electric heater 6 for the fuel cell 1 in such a way to allow the temperature drop speed Vc of the fuel cell 1 to be maintained between the first given speed Vs1 and the second given speed Vs2 that is less than the first given speed Vs1.

That is, in consecutive step S104, the control unit 5 discriminates whether the temperature drop speed Vc of the fuel cell 1 satisfies a condition in which the temperature drop speed Vc of the fuel cell 1 is equal to or less than the first given speed Vs1 and greater than the second given speed Vs2. If no such a condition is satisfied, in consecutive step S105, the control unit 5 discriminates whether, due to a heating shortage of the electric heater 6, the temperature drop speed Vc of the fuel cell 1 remains unchanged to exceed the first given speed Vs1. On the contrary, in step S104, if discrimination is made that no condition is present in which the temperature drop speed Vc of the fuel cell 1 remains unchanged to exceed the first given speed Vs1, the operation proceeds to step S108.

Then, the operation proceeds to step S105 and if discrimination is made that the temperature drop speed Vc of the fuel cell 1 remains unchanged to exceed the first given speed Vs1, in succeeding step S106, the control unit 5 controllably increases the output of the electric heater 6 to raise a heating capacity HP. On the contrary, if the temperature drop speed Vc of the fuel cell 1 does not remain unchanged to exceed the first given speed Vs1, that is, when the temperature drop speed Vc of the fuel cell 1 becomes equal to or less than the second given speed Vs2 due to the beating of the electric heater 6 in excess, in succeeding step S107, the control unit 5 controls so as to decrease the output of the electric heater 6 to lower heating capacity HP.

In step S104, if discrimination is made that the temperature drop speed Vc of the fuel cell 1 satisfies a condition under which the temperature drop speed Vc of the fuel cell 1 is equal to or less than the first given speed Vs1 and greater than the second given speed Vs2 and the operation proceeds to step S108, the control unit 5 acquires a temperature difference ΔT between the temperature of the fuel cell 1 and the environmental temperature in the vicinity of the fuel cell 1 based on the detected values of the temperature sensors 7, 8 and discriminates whether this temperature difference ΔT becomes equal to or less than a given temperature difference ΔTs. In the stage wherein the temperature difference ΔT between the temperature of the fuel cell 1 and the environmental temperature in the vicinity of the fuel cell 1 becomes equal to or less than the given temperature difference ΔTs, the control unit 5 sends a stop command to the electric heater 6 in step S109, causing the electric heater 6 to stop heating the fuel cell 1.

As set forth above, with the structure of the presently filed embodiment, the control unit 5 calculates the temperature drop speed of the fuel cell 1 during a halt of the system to activate the electric heater 6 for heating the fuel cell 1 under circumstances where the temperature drop speed of the fuel cell 1 exceeds the given speed (Vs1) such that the temperature of the fuel cell 1 is gradually lowered at a temperature drop speed equal to or less than the given speed to approach to the environmental temperature, thereby effectively keeping the fuel cell 1 from degrading in performance due to the rapid drop in temperature of the fuel cell 1.

That is, under circumstances where during the halt of the system, the environmental temperature in the vicinity of the fuel cell 1 reaches an extremely low temperature like a below-freezing temperature, if the fuel cell 1 rapidly cooled at a high temperature drop speed as shown by a dotted line A in FIG. 5, degradation occurs in the I-V characteristic of the fuel cell 1 with a resultant tendency wherein a desired voltage is unavailable to be obtained particularly at a high current density region. On the contrary, with the fuel cell system of the presently filed embodiment, as indicated by a solid line B in FIG. 5, the temperature drop speed of the fuel cell 1 is arranged to be lowered to allow the fuel cell 1 to be gradually cooled, thereby effectively preventing degradation in the I-V characteristic of the fuel cell 1 set forth above. Incidentally, in FIG. 5, an abscissa and ordinate designate a current density 1 and a voltage V of the fuel cell, respectively.

Further, with the structure of the present invention, since the fuel cell 1 is not heated by the electric heater 6 to preclude the drop in temperature of the fuel cell 1 during the halt of the system but the fuel cell 1 is heated in a way to prevent the temperature drop speed from exceeding the given speed while permitting the temperature drop of the fuel cell 1, energy needed for heating may fall in a negligible value. Accordingly, it becomes possible to effectively prevent performance degradation of the fuel cell 1 while effectively avoiding the issues, such as deterioration in efficiency, as a result of continuous consumption of a large amount of energy for the heating.

Incidentally, with the structure of the presently filed embodiment, while the control unit 5 is configured to read the detected value of the temperature sensor 7 to follow the detected value in terms of time for calculating the temperature drop speed of the fuel cell 1, an alternative way may be, of course, possible such that the temperature drop speed of the fuel cell 1 is obtained in a map indicative of the relationship between the temperature of the fuel cell 1 and the environmental temperature in the vicinity of the fuel cell 1, that is, the relationship related to a difference between the temperature drop speed of the fuel cell and the detected values, of the temperature sensors 7, 8 in preliminary step for thereby estimating the temperature drop speed of the fuel cell 1 based on the map.

In case where using such a method allows the estimation of the temperature drop speed of the fuel cell 1 based on which the operation of the electric heater 6 is controlled, the temperature drop speed of the fuel cell 1 can be discriminated within a short period of time without following the detected value of the temperature sensor 7 in terms of time, making it possible to rapidly execute the operation control of the electric heater 6.

### Second Embodiment

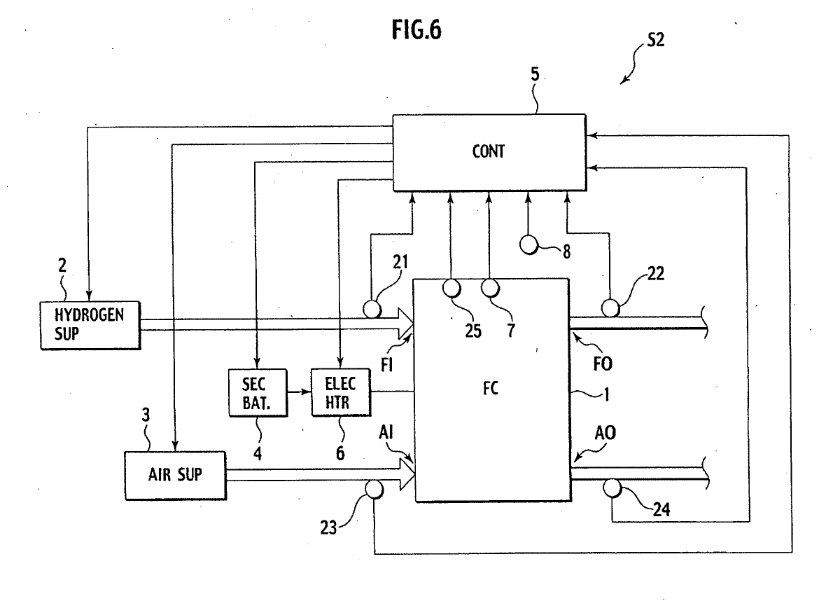

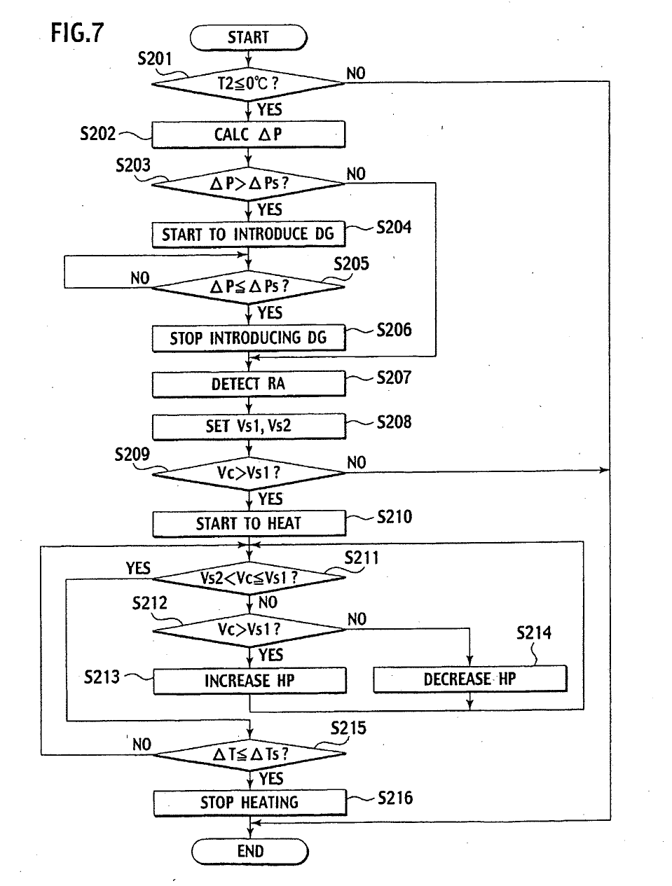

Next, a control device of a fuel cell system and its related method of the presently filed embodiment according to the present invention are described in detail with reference to FIGS. 6 and 7.

FIG. 6 is a view illustrating a block diagram of a fuel cell system of the presently filed embodiment, and FIG. 7 is a flowchart illustrating the operation control of the electric heater to be executed by the control unit in the fuel cell system of the presently filed embodiment.

The fuel cell system of the presently filed embodiment mainly differs from that of the first embodiment in that, in consideration of the characteristic wherein performance degradation of the fuel cell during the temperature drop thereof also depends on a moisture content remaining inside the fuel cell 1, control is executed so as to vary the reference values (the first given speed Vs1 and the second given speed Vs2) forming a criteria for the heating control of the fuel cell 1, that is, of the operation control of the electric heater 6, depending on the residual moisture content of the inside of the fuel cell 1. Hereunder, with attention focused on such a difference, the same component parts bear like reference numerals and description of the same is suitably omitted or simplified.

As shown in FIG. 6, the fuel cell system S2 of the presently filed embodiment further includes, in addition to the structure of the first embodiment, pressure sensors 21, 22, 23, 24 that are located in a fuel-electrode inlet FI and outlet FO and an oxidizer-electrode inlet AI and outlet AO of the fuel cell 1, respectively. Also, mounted to the fuel cell 1 is a resistance value sensor 25 that detects a resistance value of the fuel cell 1. Detected values resulting from these sensors 21, 22, 23, 24, 25 are inputted to the control unit 5.

With such a structure, the control unit 5 reads the detected values delivered from the respective pressure sensors 21, 22 associated with the fuel-electrode sides to detect a differential pressure between the fuel-electrode inlet and outlet of the fuel cell 1. Likewise, the control unit 5 reads the detected values delivered from the respective pressure sensors 23, 24 associated with the oxidizer-electrode sides to detect a differential pressure between the oxidizer-electrode inlet and outlet of the fuel cell 1. Then, the control unit 5 discriminates from these differential pressures whether liquid water stays in gas flow channels of the fuel-electrode side and the oxidizer-electrode side in the inside of the fuel cell 1. If discrimination is made that liquid water stays in the gas flow channels, the control unit 5 drives the hydrogen supply unit 2 and the air supply unit 3 to introduce dry gases into the gas flow channels inside the fuel cell 1, thereby purging residual liquid water from the gas flow channels.

That is, during normal operation, for the purpose of humidifying the solid polymer electrolyte membrane of the fuel cell 1, hydrogen and air are supplied to the fuel cell 1 from the hydrogen supply unit 2 and the air supply unit 3, respectively, with hydrogen and air being humidified, and when executing the purging as set forth above during a halt of the system, hydrogen and air are supplied to the fuel cell 1 as dry gases from the hydrogen supply unit 2 and the air supply unit 3, respectively.

Further, upon carrying out the purging as set forth above depending on needs, the control unit 5 reads the detected value of the resistance value sensor 25 and estimates the moisture content remaining in the inside of the fuel cell 1 based on the detected value of the resistance value sensor 25. Here, due to the presence of ability in that liquid water remaining in the gas flow channels are mostly expelled by purging, residual moisture includes a moisture mainly contained inside the solid polymer electrolyte membrane and gas diffusion layer. Then, the control unit 5 varies the first given speed Vs1 and the second given speed Vs2, forming the criteria for the operation control of the electric heater 6, depending on the estimated residual moisture content inside the fuel cell 1.

More particularly, the control unit 5 determines such that the larger the residual moisture content inside the fuel cell 1, the smaller will be the values of the first given speed Vs1 and the second given speed Vs2. Thereafter, the control unit 5 controls the operation of the electric heater 6 like in the first embodiment, set forth above, to eliminate a rapid temperature drop of the fuel cell 1, thereby keeping the fuel cell 1 from degrading in performance thereof.

A further concrete content of controlling the operation of the control unit 5 for operating the electric heater 6 is described with reference to a flowchart shown in FIG. 7.

As shown in FIG. 7, during a halt of the system, first in step S201, the control unit 5 reads the detected value of the temperature sensor 8 to acquire the environmental temperature in the vicinity of the fuel cell 1, like in step S101 of the first embodiment, and discriminates whether the environmental temperature in the vicinity of the fuel cell 1 is equal to or less than 0° C. Here, if the environmental temperature in the vicinity of the fuel cell 1 exceeds 0° C., the operation is finished intact and if the environmental temperature in the vicinity of the fuel cell 1 is equal to or less than 0° C., the operation proceeds to step S202.

Next, in step S202, the control unit 5 monitors the detected values of the pressure sensors 21, 22, 23, 24, respectively, so as to calculate differential pressures ΔP between the fuel-electrode inlet and outlet and between the oxidizer-electrode inlet and outlet of the fuel cell 1, respectively.

In succeeding step S203, the control unit 5 discriminates whether the calculated differential pressures ΔP exceed a given reference value ΔPs. Incidentally, the given differential pressure ΔPs, which forms a criterion, corresponds to a differential pressure equivalent to the moisture content, by which no adverse affects, such as damages, occur on the fuel cell 1 even when the freezing occurs in the gas flow channels inside the fuel cell 1, or a value slightly less than such a differential pressure and may be preliminarily obtained upon experimental tests.

Here, if the calculated differential pressures ΔP exceed the given differential pressure ΔPs, the control unit 5 discriminates that there is a probability for damages to occur to the fuel cell 1 due to the freezing of water inside the fuel cell 1 during a temperature drop thereof and, in consecutive step S204, permits dry gases DG to be introduced to the inside of the fuel cell 1 to purge residual liquid water from the gas flow channels.

In subsequent step S205, upon monitoring the differential pressures ΔP between the fuel-electrode inlet and outlet and between the oxidizer-electrode inlet and outlet of the fuel cell 1, the control unit 5 discriminates whether the purging of liquid water due to dry gases is properly performed and, in consecutive step S206, the control unit 5 stops introducing dry gases on the stage wherein the differential pressures ΔP become equal to or less than the given differential pressure ΔPs.

Next, in step S207, the control unit 5 reads the detected value RA of the resistance sensor 25 and, depending on the detected value RA, estimates the moisture content remaining inside the fuel cell 1.

In consecutive step S208, the control unit 5 determines a first given speed Vs1 and a second given speed Vs2, forming criteria for the operation control of the electric heater 6, depending on the estimated residual moisture content of the fuel cell 1.

Subsequently, in steps S209 to S216, the control unit 5 executes the same operations as those of steps S102 to S109 of the first embodiment to efficiently heat the fuel cell 1 using the electric heater 6, thereby suppressing a rapid temperature drop of the fuel cell 1 for thereby keeping the fuel cell 1 from performance degradation.

As set forth above, with the Structure of the presently filed embodiment, the control unit 5 estimates the moisture content remaining inside the fuel cell 1 and, depending on the estimated residual moisture content, sets the first given speed Vs1 and the second given speed Vs2, forming criteria for the operation control of the electric heater 6, so as to control the operation of the electric heater 6, thereby more reliably keeping the fuel cell 1 from degrading in performance thereof due to a rapid drop in temperature of the fuel cell 1.

Further, under circumstances where a large amount of liquid water stays in the gas flow channels inside the fuel cell 1 during the halt of the system, introducing dry gases allows liquid water to be discharged outside the fuel cell 1, thereby effectively avoiding the fuel cell 1 from probabilities that would cause damages to the fuel cell 1 due to the freezing of liquid water accompanied by the temperature drop of the fuel cell 1.

### Third Embodiment

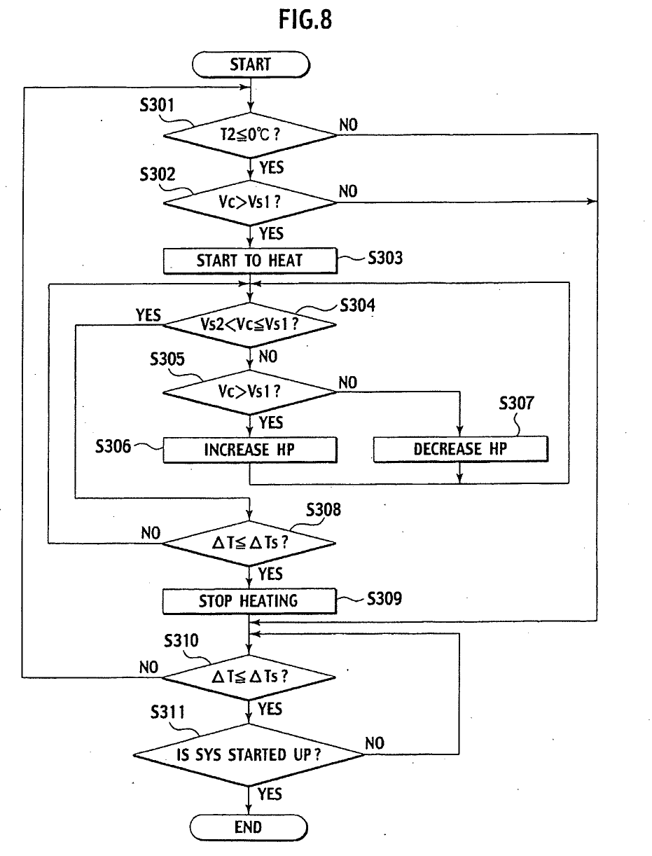

Next, a control device of a fuel cell system and its related method of a third embodiment according to the present invention are described in detail with reference to FIG. 8.

FIG. 8 is a flowchart illustrating the operation control of the electric heater to be executed by a control unit in a fuel cell system of the presently filed embodiment.

The fuel cell system of the presently filed embodiment mainly differs from that of the first embodiment in that, in order to be also able to respond to the occurrence of a rapid drop in environmental temperatures in the vicinity of the fuel cell 1 after stopping heating the fuel cell 1 with the electric heater 6, the heating of the fuel cell 1 with the electric heater 6 is re-started in the presence of a rapid drop in the temperature of the fuel cell 1 followed by a rapid drop in the environmental temperatures. Hereunder, with attention focused on such a difference, the same component parts bear like reference numerals to suitably omit or simplify description of the same.

As shown in FIG. 8, the control unit of the presently filed embodiment executes the same operations as those (steps S101 to steps S109) of the first embodiment in steps S301 to S309 to efficiently heat the fuel cell 1 with the electric heater 6, thereby suppressing a rapid drop in temperature of the fuel cell 1 to prevent performance degradation thereof.

Thereafter, in an event that the environmental temperature in the vicinity of the fuel cell 1 varies with a resultant increase in a temperature difference between the temperature of the fuel cell 1 and the environmental temperature to cause a temperature drop in the fuel cell 1, a temperature drop speed of the fuel ell 1 is calculated again and the control unit 5 discriminates whether the temperature drop speed exceeds a given value, whereupon if the temperature drop speed exceeds the given value, the heating of the fuel cell 1 with the electric heater 6 is restarted.

That is, after the heating of the fuel cell 1 with the electric beater 6 is stopped in step S309, in succeeding step S310, the control unit 5 monitors to find whether the fuel cell 1 is maintained under a condition where a temperature difference Δ T between the temperature of the fuel cell 1 and the environmental temperature close proximity to the fuel cell 1 is equal to or less than a given preset temperature difference ΔTs. If the temperature difference ΔT between the temperature of the fuel cell 1 and the environmental temperature in the vicinity of the fuel cell 1 exceeds the given preset temperature difference ΔTs, discrimination is made that variation occurs in the environmental temperature in the vicinity of the fuel cell 1 and the operation proceeds to step S301 whereupon subsequent series of operations are repeatedly executed.

In the meanwhile, in step S310, if discrimination is made that the temperature difference ΔT between the temperature of the fuel cell 1 and the environmental temperature in the vicinity of the fuel cell 1 is maintained under a condition equal to or less than the given preset temperature difference ΔTs, the operation proceeds to step S311.

In succeeding step S311, discrimination is made whether the fuel cell system is started up and if discrimination is made that the fuel cell system has been started up, the above-described series of operations are finished whereupon the operation proceeds to a given system start-up operation. On the contrary, if discrimination is made that no start-up operation of the fuel cell system has been executed, the operation is routed back to step S310.

As set forth above, with the structure of the presently filed embodiment, since under circumstances where after the heating of the fuel cell 1 is stopped, a rapid drop occurs in the environmental temperature in the vicinity of the fuel cell 1 with the resultant occurrence of a rapid drop in the temperature of the fuel cell 1, the heating of the fuel cell 1 with the electric heater 6 is restarted, the fuel cell 1 also responds to the rapid drop in the environmental temperature of the fuel cell 1, thereby further reliably keeping the fuel ell 1 from degrading in performance thereof due to a rapid drop in temperature of the fuel cell 1.

### Fourth Embodiment

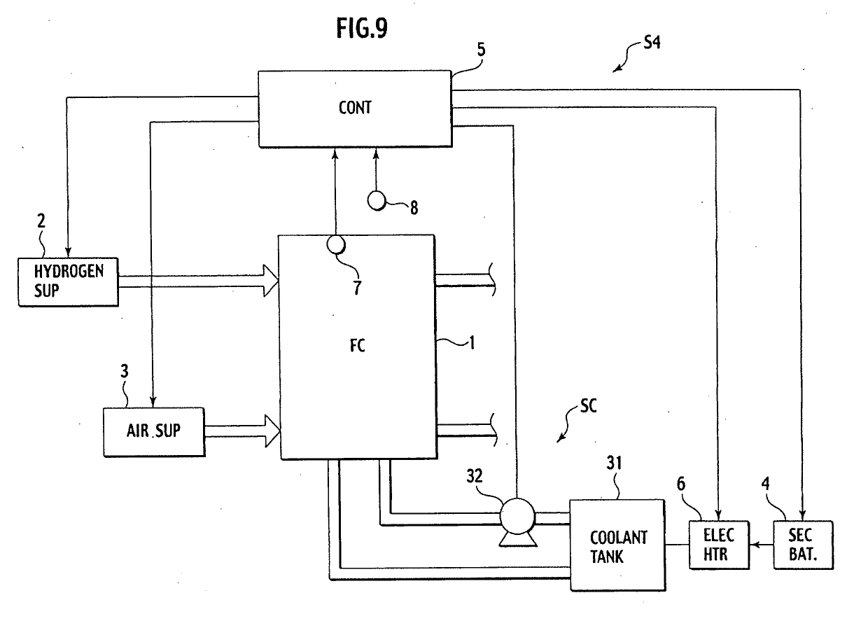

Next, a control device of a fuel cell system and its related method of a fourth embodiment according to the present invention are described in detail with reference to FIG. 9.

FIG. 9 is a view illustrating a block diagram of a fuel cell system of the presently filed embodiment.

The fuel cell system of the presently filed embodiment mainly differs from that of the first embodiment in that the fuel cell 1 employs a coolant supply unit, by which coolant is circulated and supplied to the fuel cell 1 for temperature regulation, as a heating mechanism for heating the fuel cell 1. Hereunder, with attention focused on such a difference, the same component parts bear like numerals to suitably omit or simplify description of the same.

As shown in FIG. 9, with the fuel cell system S4 of the presently filed embodiment, the coolant supply unit SC is connected to the fuel cell 1.

The coolant supply unit SC serves to allow coolant, stored in a coolant tank 31, to be circulated for supply to the fuel cell 1 by operating a pump 32. Accordingly, supplying coolant to the fuel cell 1 under heated condition enables the fuel cell 1 to be heated and, with the fuel ell system S4 of the presently filed embodiment, the coolant supply unit is employed as the heating mechanism. Also, the electric heater 6, which takes the secondary battery 4 as a power supply, may be applied as a heat source for heating coolant and, with the fuel cell system S4 of the presently filed embodiment, the electric heater 6 is placed in a position close proximity to the coolant tank 31 to enable heat of the electric heater 6 to heat coolant stored in the coolant tank 31. Incidentally, it is sufficed for a position at which the electric heater 6 is placed to take any location as far as the coolant tank 31 can be heated and, quoad hoc, the electric heater 6 to be placed separate from the coolant tank 31.

A control content of the control unit 5 of the presently filed embodiment includes, in addition to the operation control of the electric heater 6 of the first embodiment, controlling the operation of the pump 32 of the coolant supply unit SC for efficiently heating the fuel cell 1 such that the temperature drop speed of the fuel cell 1 during a drop in temperature does not exceed a given reference value (first given speed Vs1).

As set forth above, even with the fuel cell system S4 of the presently filed embodiment, like in the first embodiment, under circumstances where during a halt of the system, the environmental temperature in the vicinity of the fuel cell 1 is low to cause a drop in temperature in the fuel cell 1, the fuel cell 1 is heated to allow the temperature drop speed of the fuel cell 1 not to exceed the given reference value such that the temperature of the fuel cell 1 gradually lowers to approach to the environmental temperature, effectively keeping the fuel cell 1 from degrading in performance due to a rapid drop in temperature of the fuel cell 1.

Further, with the fuel cell system of the presently filed embodiment S4, supplying coolant, which is heated inside the fuel cell 1, to the fuel cell 1 for heating the same allows the fuel cell 1 to be heated and, therefore, the fuel cell 1 can be heated with less energy than that required for heating the fuel cell 1 from an outside thereof by the use of the electric heater 6, thereby further efficiently heating the fuel cell 1 for keeping the fuel cell 1 degrading in performance thereof.

### Fifth Embodiment

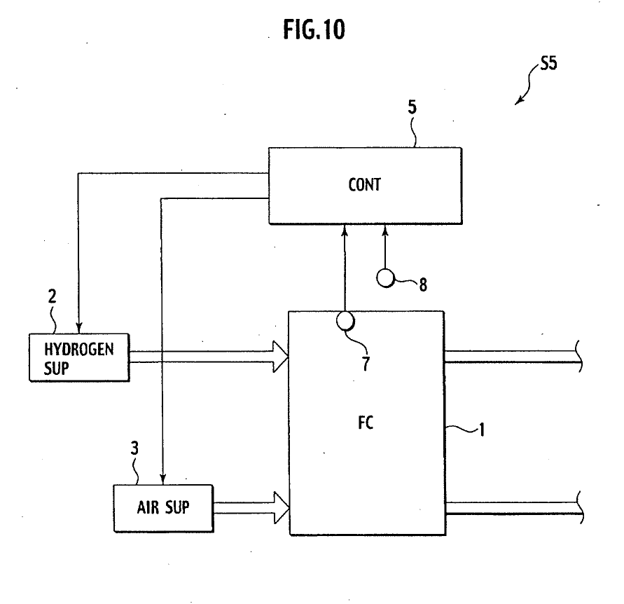

Next, a control device of a fuel cell system and its related method of a fifth embodiment according to the present invention are described in detail with reference to FIG. 10.

FIG. 10 is a view showing a block diagram of the fuel cell system of the presently filed embodiment.

The fuel cell system of the presently filed embodiment mainly differs from that of the first embodiment in that the fuel cell 1 utilizes heal developed by catalytic combustion between hydrogen and oxygen in air in the fuel cell 1 to heat the same. Hereunder, with attention focused on such a difference, the same component parts bear like numerals to suitably omit or simplify description of the same.

As shown in FIG. 10, with the fuel cell system S5 of the presently filed embodiment, no additional heating mechanism, like the electric heater 6, is employed and, in place thereof, hydrogen and air are supplied to the fuel cell 1 from the hydrogen supply unit 2 and the air supply unit 3 at respective flow rates needed for heating the fuel cell 1 during a halt of the fuel cell system to allow hydrogen and oxygen in air to be catalytically combusted inside the fuel cell 1 for utilizing the resulting heat to heat the fuel cell 1.

A control content of the control unit 5 of the presently filed embodiment includes, in place of controlling the operation of the electric heater 6 of the first embodiment, controlling operations of the hydrogen supply unit 2 and the air supply unit 3. That is, with the structure of the presently filed embodiment, under circumstances where a rapid temperature drop of the fuel cell 1 is concerned during a halt of the system, controlling the hydrogen supply unit 2 and the air supply unit 3 allows hydrogen and air to be supplied to the fuel cell 1 at respective given flow rates for utilizing heat developed by catalytic combustion between hydrogen and oxygen in air in the fuel cell 1 for thereby heating the fuel cell 1 such that the temperature drop speed of the fuel cell 1 does not exceed the given reference value (first given speed Vs1).

As set forth above, even with the fuel cell system S5 of the presently filed embodiment, like in the first embodiment, under circumstances where during a halt of the system, the environmental temperature in the vicinity of the fuel cell 1 is low to cause a drop in temperature in the fuel cell 1, the fuel cell 1 is heated to allow the temperature drop speed of the fuel cell 1 not to exceed the given reference value such that the temperature of the fuel cell 1 gradually lowers to approach to the environmental temperature, effectively keeping the fuel cell 1 from degrading in performance due to a rapid drop in temperature of the fuel cell 1.

Further, with the fuel cell system S5 of the presently filed embodiment, since the fuel cell 1 is heated by utilizing heat developed by catalytic combustion between hydrogen and oxygen in air in the fuel cell 1, the fuel cell 1 can be heated with less energy than that required for heating the fuel cell 1 from an outside thereof by the use of the electric heater 6, thereby further efficiently keeping the fuel cell 1 from degrading in performance.

Additionally, since the fuel cell system S5 of the presently filed embodiment is arranged to heat the fuel cell 1 without providing a specific heating mechanism, such as the electric heater 6, the miniaturization of a whole of the system can be realized. Additionally, even in the presence of temperature environments at extremely low temperatures where normal operation of the electric heater 6 is unavailable, properly heating the fuel cell 1 enables the fuel cell 1 to be effectively prevented from degrading in performance due to a rapid drop in temperature of the same.

Incidentally, while in the foregoing description, there has been shown a concrete structure for heating the fuel cell 1, the structure for heating the fuel cell 1 is not limited to such a particular structure and various alternative structures may be adopted as far as the temperature drop speed of the fuel cell 1 is controllably carried out. One of such alternatives may include a structure that combines the heating of the fuel cell 1 from outside with the electric heater 6 and the heating of the fuel cell 1 in the inside thereof due to catalytic combustion whereby during normal operation, the electric heater 6 is used for heating the fuel cell 1 and, in the absence of an adequate heating value with the electric heater 6, hydrogen and air are supplied to the fuel cell 1 from the hydrogen supply unit and the air supply unit at respectively necessary flow rates to allow hydrogen and oxygen in air to catalytically combust in the fuel cell 1 to develop heat for utilization to heat the fuel ell 1.

The entire content of a Patent Application No. TOKUGAN 2004-037148 with a filing date of Feb. 13, 2004 in Japan is hereby incorporated by reference.

Although the invention has been described above by reference to certain embodiments of the invention, the invention is not limited to the embodiments described above. Modifications and variations of the embodiments described above will occur to those skilled in the art, in light of the teachings. The scope of the invention is defined with reference to the following claims.

### INDUSTRIAL APPLICABILITY

As set forth above, according to a fuel cell system and related method of the present invention, since a fuel cell is heated with a heating mechanism in a way to allow a temperature drop speed to be set to a value equal to or less than a given speed during a drop in temperature of a fuel cell, it becomes possible to effectively keep the fuel cell from degrading in performance due to the drop in temperature of the fuel cell while effectively avoiding issues such as degradation in efficiency as a result of continuously consuming a large amount of energy for the heating. Therefore, such a fuel cell system is applicable to a variety of fuel cell systems that are used under environments susceptible to drops in temperature and thus electric power generators such as those of fuel cell powered automotive vehicles and those for industrial use or domestic use, with its application being expected in wide ranges.

1. A fuel cell system comprising:
a fuel cell supplied with fuel and oxidizer to generate electric power;
a heating mechanism executing a heating to the fuel cell;
a temperature detector detecting a temperature of the fuel cell; and
a controller operative to calculate a temperature drop speed of the fuel cell, during a period in which the temperature of the fuel cell is lowering, using the temperature of the fuel cell detected by the temperature detector to control the heating mechanism such that the temperature drop speed is kept equal to or less than a given speed.

2. The fuel cell system according to claim 1, wherein the controller causes the heating mechanism to start to execute the heating to the fuel cell when the temperature drop speed exceeds the given speed.

3. The fuel cell system according to claim 2, further comprising an environment temperature detector detecting an environmental temperature of the fuel cell,
wherein the controller causes the heating mechanism to start to execute the heating to the fuel cell when the environmental temperature is equal to or less than zero degree.

4. The fuel cell system according to claim 2, wherein the controller raises a heating capacity of the heating mechanism in case where after the heating mechanism has started the heating, the temperature drop speed does not become equal to or less than the given speed.

5. The fuel cell system according to claim 2, wherein the controller lowers a heating capacity of the heating mechanism in case where after the heating mechanism has started the heating, the temperature drop speed becomes equal to or less than a second given speed lower than the given speed.

6. The fuel cell system according to claim 3, wherein the controller stops the heating mechanism in case where a temperature difference between the temperature of the fuel cell and the environmental temperature becomes equal to or less than a given temperature difference.

7. The fuel cell system according to claim 6, wherein the controller restarts the heating of the heating mechanism in case where after the heating mechanism has stopped the heating, the environmental temperature further lowers and the temperature drop speed further exceeds the given speed.

8. The fuel cell system according to claim 1, further comprising a resistance value detector detecting a resistance value of the fuel cell,
wherein the controller estimates a moisture content remaining in an inside of the fuel cell based on the resistance value, detected by the resistance value detector, and varies a value of the given speed depending on the moisture content.

9. The fuel cell system according to claim 8, wherein the controller estimates the moisture content remaining in the inside of the fuel cell after executing a purging of the fuel cell.

10. The fuel cell system according to claim 3, wherein the controller estimates the temperature drop speed based on a temperature difference between the temperature of the fuel cell and the environmental temperature.

11. The fuel cell system according to claim 1, wherein the heating mechanism includes an electric heater that takes a secondary battery as a heat source.

12. The fuel cell system according to claim 1, wherein the heating mechanism includes a coolant supply mechanism that heats coolant and supplies the same to the fuel cell.

13. The fuel cell system according to claim 12, wherein a heat source heating the coolant includes an electric heater that takes a secondary battery as a power supply.

14. The fuel cell system according to claim 1, wherein the heating mechanism heats the fuel cell utilizing a heat built up by catalytic combustion between the fuel and the oxidizer in the fuel cell.

15. A fuel cell system comprising:
a fuel cell supplied with fuel and oxidizer to generate electric power;
heating means for executing a heating to the fuel cell;
temperature detection means for detecting a temperature of the fuel cell; and
control means, by calculating a temperature drop speed of the fuel cell, during a period in which the temperature of the fuel cell is lowering, based on the temperature of the fuel cell detected by the temperature detection means, for controlling the heating means such that the temperature drop speed is kept equal to or less than a given speed.

16. A method of controlling a fuel cell system having a fuel cell supplied with fuel and oxidizer to generate electric power, the method comprising:
detecting a temperature of the fuel cell;
calculating a temperature drop speed, during a period in which the temperature of the fuel cell is lowering, using the temperature of the fuel cell; and
executing a heating to the fuel cell such that the temperature drop speed is kept equal to or less than a given speed.
